(19) United States
(12) Patent Application Publication
(10) Pub. No.: US 2024/0183681 A1
(43) Pub. Date: Jun. 6, 2024

(54) VIDEO MANAGEMENT APPARATUS, VIDEO MANAGEMENT METHOD, AND NON-TRANSITORY COMPUTER READABLE MEDIUM

(71) Applicant: TOYOTA JIDOSHA KABUSHIKI KAISHA, Aichi-ken (JP)

(72) Inventors: Sayaka TSUBOTA, Nagoya-shi (JP); Masato KOIKE, Kasugai-shi (JP)

(21) Appl. No.: 18/518,605

(22) Filed: Nov. 24, 2023

(30) Foreign Application Priority Data
Dec. 1, 2022 (JP) 2022-193131

(51) Int. Cl. G01C 21/36

(52) U.S. Cl. CPC G01C 21/367; G01C 21/3617

(57) ABSTRACT

A video management apparatus includes a controller configured to display, on a map displayed on a screen of the terminal apparatus, an icon indicating a position and an orientation, at a time at which a video is captured, of each vehicle that stores the video, the video having been captured within a predetermined area including a designated point on the map, acquire, upon any icon being selected from among one or more icons displayed on the map, a video captured by the vehicle corresponding to the selected icon, and play back the acquired video.

### CROSS-REFERENCE TO RELATED APPLICATION

This application claims priority to Japanese Patent Application No. 2022-193131 filed on Dec. 1, 2022, the entire contents of which are incorporated herein by reference.

### TECHNICAL FIELD

The present disclosure relates to a video management apparatus, a video management method, and a non-transitory computer readable medium.

### BACKGROUND

Technology for managing video captured by vehicles is known. For example, the display control apparatus disclosed in Patent Literature (PTL) 1 receives, from a vehicle, images of an imaging target location, captured by the vehicle, and displays the received captured images. Even in a case in which there is no vehicle capable of capturing images of the imaging target location, if captured images of the imaging target location can be received from a vehicle that has stored the captured images, the display control apparatus receives the captured images from that vehicle and displays the received captured images.

### CITATION LIST

### Patent Literature

PTL 1: JP 2019-215638 A

### SUMMARY

The technology disclosed in PTL 1 simply reproduces and displays received video or images. However, in the case of numerous videos or images, the technology disclosed in PTL 1 has difficulty in selecting the video or images to be acquired.

Therefore, there is room for improvement in technology for managing video captured by a vehicle.

It would be helpful to improve technology for managing video captured by a vehicle.

A video management apparatus according to an embodiment of the present disclosure is a video management apparatus capable of communicating with a terminal apparatus, the video management apparatus including:
a controller configured to display, on a map displayed on a screen of the terminal apparatus, an icon indicating a position and an orientation, at a time at which a video is captured, of each vehicle that stores the video, the video having been captured within a predetermined area including a designated point on the map, acquire, upon any icon being selected from among one or more icons displayed on the map, a video captured by the vehicle corresponding to the selected icon, and play back the acquired video.

A video management method according to an embodiment of the present disclosure is a video management method to be executed by a video management apparatus capable of communicating with a terminal apparatus, the video management method including:
displaying, on a map displayed on a screen of the terminal apparatus, an icon indicating a position and an orientation, at a time at which a video is captured, of each vehicle that stores the video, the video having been captured within a predetermined area including a designated point on the map;
acquiring, upon any icon being selected from among one or more icons displayed on the map, a video captured by the vehicle corresponding to the selected icon; and
playing back the acquired video.

A non-transitory computer readable medium according to an embodiment of the present disclosure stores a program configured to cause a video management apparatus capable of communicating with a terminal apparatus to execute operations, the operations including:
displaying, on a map displayed on a screen of the terminal apparatus, an icon indicating a position and an orientation, at a time at which a video is captured, of each vehicle that stores the video, the video having been captured within a predetermined area including a designated point on the map;
acquiring, upon any icon being selected from among one or more icons displayed on the map, a video captured by the vehicle corresponding to the selected icon; and
playing back the acquired video.

According to an embodiment of the present disclosure, technology for managing video captured by a vehicle is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a video management apparatus;

FIG. 3 is a flowchart illustrating operations of the video management apparatus;

FIG. 4 is a diagram illustrating an example of a video acquisition screen;

FIG. 5 is a diagram illustrating an example of a screen displaying information indicating the time at which a video was captured; and

FIG. 6 is a diagram illustrating an example of processing in the case of two or more icons of the same vehicle being displayed.

### DETAILED DESCRIPTION

Hereinafter, an embodiment of the present disclosure will be described.

### Outline of Embodiment

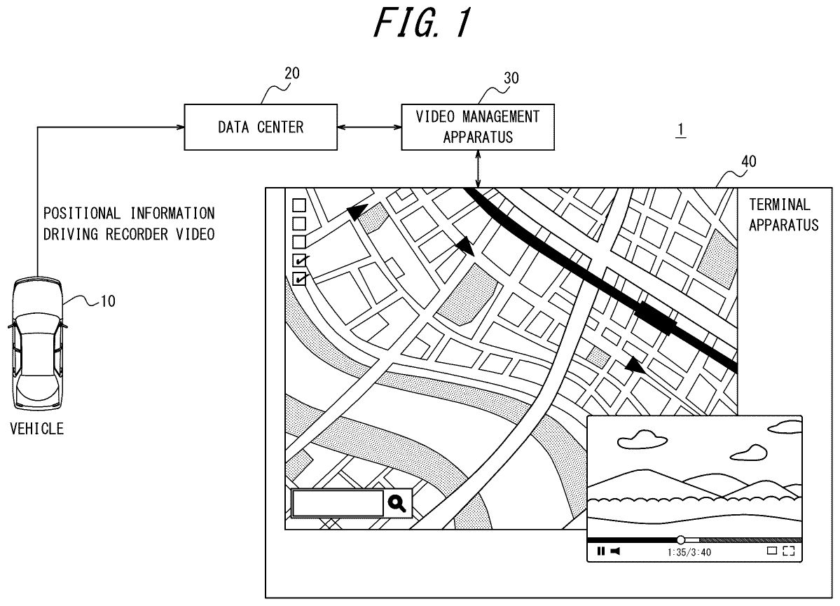

An outline of a system 1 according to an embodiment of the present disclosure will be described with reference to FIG. 1. The system 1 includes a vehicle 10, a data center 20, a video management apparatus 30, and a terminal apparatus 40. The vehicle 10, the data center 20, the video management apparatus 30, and the terminal apparatus 40 are communicably connected to a network 2 including, for example, the Internet, a mobile communication network, and the like.

The vehicle 10 is an automobile, for example, but is not limited to this and may be any appropriate vehicles. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 provided in the system 1 may be freely determined.

In the present embodiment, the vehicle 10 includes a receiver that, at predetermined time intervals, receives positional information for the vehicle while the vehicle 10 is traveling and a driving recorder that captures and stores video of the surroundings. The vehicle 10 can communicate with the data center 20 and the video management apparatus 30 via the network 2. Hereinafter in the present disclosure, the positional information refers to data including the position and orientation of the vehicle 10.

The data center 20 stores the positional information and the driving recorder video (hereinafter referred to as “video”) for the vehicle 10. The data center 20 is, for example, a computer such as a server apparatus. The data center 20 can communicate with the vehicle 10 and the video management apparatus 30 via the network 2. The data center 20 receives and stores the positional information and video from a plurality of vehicles 10 at predetermined time intervals.

The video management apparatus 30 manages the video captured by the vehicle 10. The video management apparatus 30 is, for example, a computer such as a server apparatus. The video management apparatus 30 can communicate with the vehicle 10, the data center 20, and the terminal apparatus 40 via the network 2.

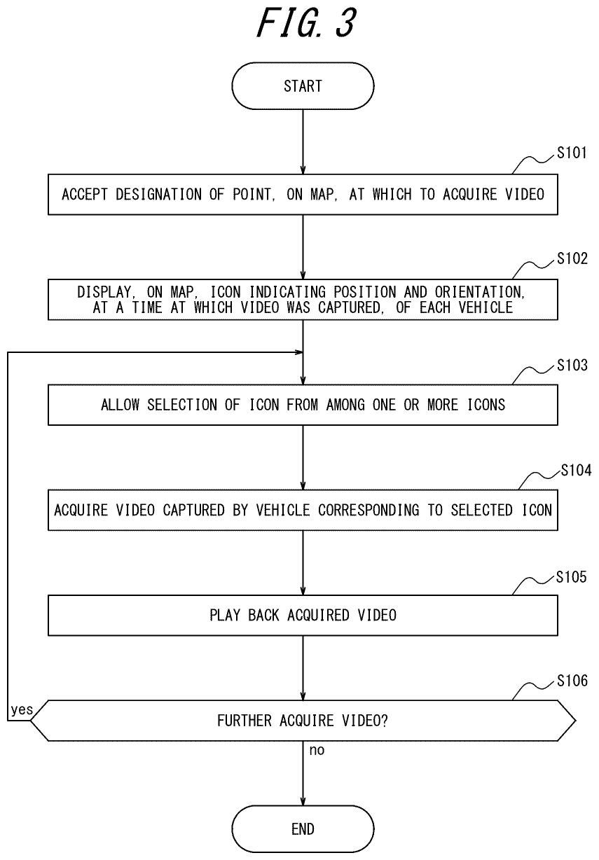

As illustrated in FIG. 3, the terminal apparatus 40 displays a map, a video acquisition screen, and the like on the screen and accepts input from the user. The terminal apparatus 40 is, for example, a smartphone, a tablet, a personal computer (PC), or the like. The terminal apparatus 40 is communicably connected to the video management apparatus 30 via the network 2. The terminal apparatus 40 may be directly wired to the video management apparatus 30.

First, an outline of the present embodiment will be described, and details thereof will be described later. The video management apparatus 30 displays, on a map displayed on a screen of the communicably connected terminal apparatus 40, an icon indicating a position and an orientation, at a time at which a video is captured, of each vehicle 10 that stores the video, the video having been captured within a predetermined area including a designated point on the map. The video management apparatus 30 acquires, upon any icon being selected from among one or more icons displayed on the map, the video captured by the vehicle 10 corresponding to the selected icon, and plays back the acquired video.

In this way, according to the present embodiment, an icon indicating the position and orientation of the vehicle 10 at the time at which the video was captured, which is necessary information for selecting the video of the vehicle 10, is displayed on the map. This improves the technology for managing video captured by vehicles in that the probability of acquiring the desired video increases.

Next, configurations of the system 1 will be described in detail.

### (Configuration of Vehicle)

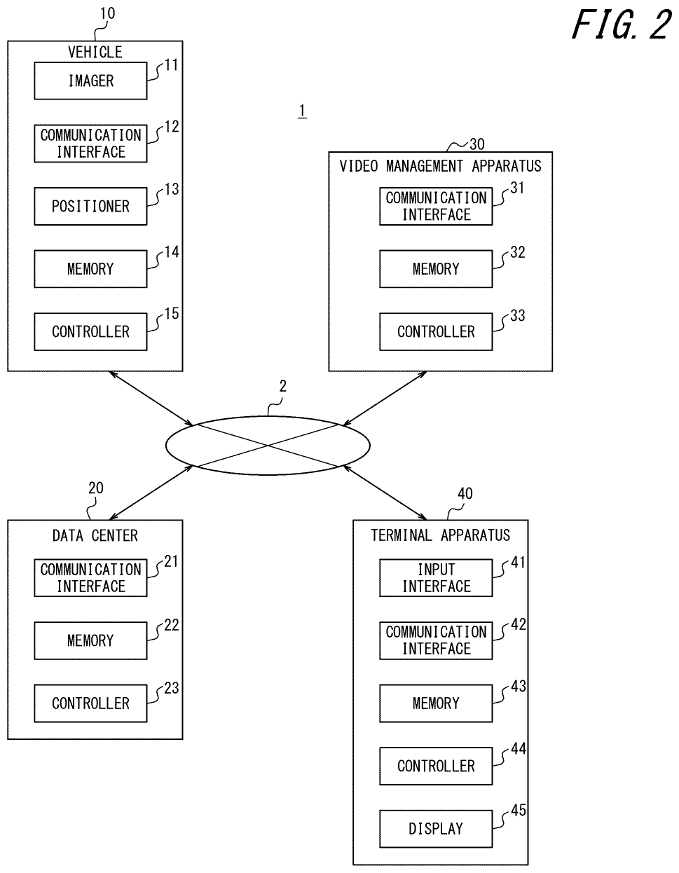

As illustrated in FIG. 2, the vehicle 10 includes an imager 11, a communication interface 12, a positioner 13, a memory 14, and a controller 15.

The imager 11 is, for example, a driving recorder installed in the vehicle 10. By including the driving recorder, the vehicle 10 can capture video of the surroundings of the vehicle 10 at predetermined time intervals while the vehicle 10 is traveling or stopped.

The communication interface 12 includes at least one interface for communication for connecting to the network 2. The communication interface is compliant with mobile communication standards such as the 4th generation (4G) standard or the 5th generation (5G) standard, for example, but these examples are not limiting. In the present embodiment, the vehicle 10 communicates with the data center 20 and the video management apparatus 30 via the communication interface 12 and the network 2.

The positioner 13 includes one or more apparatuses configured to acquire positional information for the vehicle 10. Specifically, the positioner 13 includes, for example, a receiver compliant with GPS, but is not limited to this example and may include a receiver compliant with any appropriate satellite positioning system. The positioner 13 may, for example, acquire the positional information for the vehicle 10 at 10-second time intervals.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information used for operations of the vehicle 10. For example, the memory 14 may store system programs, application programs, embedded software, positional information for the vehicle 10 as measured by a satellite positioning system, video captured by the driving recorder, and the like. The information stored in the memory 14 may be updated with, for example, information acquired from the network 2 via the communication interface 12.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire vehicle 10.

### (Configuration of Data Center)

As illustrated in FIG. 2, the data center 20 includes a communication interface 21, a memory 22, and a controller 23.

The communication interface 21 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the data center 20 communicates with the vehicle 10 and the video management apparatus 30 via the communication interface 21 and the network 2.

The memory 22 includes one or more memories. The memories included in the memory 22 may each function as, for example, a main memory, an auxiliary memory, or a cache memory. The memory 22 stores any information used for the operations of the data center 20. For example, the memory 22 may store system programs, application programs, databases, the positional information for the vehicle 10, video captured by the vehicle 10, and the like. The information stored in the memory 22 may be updated with, for example, information acquired from the network 2 via the communication interface 21.

The controller 23 includes at least one processor, at least one programmable circuit, at least one dedicated circuit, or a combination of these. The controller 23 controls operations of the entire data center 20.

### (Configuration of Video Management Apparatus)

As illustrated in FIG. 2, the video management apparatus 30 includes a communication interface 31, a memory 32, and a controller 33.

The communication interface 31 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the video management apparatus 30 communicates with the vehicle 10, the data center 20, and the terminal apparatus 40 via the communication interface 31 and the network 2.

The memory 32 includes one or more memories. The memories included in the memory 32 may each function as, for example, a main memory, an auxiliary memory, or a cache memory. The memory 32 stores any information to be used for operations of the video management apparatus 30. For example, the memory 32 may store system programs, application programs, databases, the positional information for the vehicle 10, a history of videos that have been played back a predetermined number of times by the terminal apparatus 40, and the like. The information stored in the memory 32 may be updated with, for example, information acquired from the network 2 via the communication interface 31.

The controller 33 includes at least one processor, at least one programmable circuit, at least one dedicated circuit, or a combination of these. The controller 33 controls the operations of the entire video management apparatus 30.

### (Configuration of Terminal Apparatus)

As illustrated in FIG. 2, the terminal apparatus 40 includes an input interface 41, a communication interface 42, a memory 43, a controller 44, and a display 45.

The input interface 41 is configured to include at least one interface for input that is capable of accepting an input from a user. The interface for input is, for example, a physical key, a capacitive key, a pointing device, a touch screen integrally provided with the display, a barcode reader, an IC card reader, a microphone, or the like. However, the interface for input is not limited to this.

The communication interface 42 includes at least one communication interface for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the terminal apparatus 40 communicates with the video management apparatus 30 via the communication interface 42 and the network 2. The terminal apparatus may be directly wired to the video management apparatus 30.

The memory 43 includes one or more memories. The memories included in the memory 43 may each function as, for example, a main memory, an auxiliary memory, or a cache memory. The memory 43 stores any information to be used for operations of the terminal apparatus 40. For example, the memory 43 may store system programs, application programs, databases, the positional information for the vehicle 10, a history of videos that have been played back a predetermined number of times by the terminal apparatus 40, and the like. The information stored in the memory 43 may be updated with, for example, information acquired from the network 2 via the communication interface 42.

The controller 44 includes at least one processor, at least one programmable circuit, at least one dedicated circuit, or a combination of these. The controller 44 controls operations of the entire terminal apparatus 40.

The display 45 is configured to include at least one interface for display that is capable of displaying data. The interface for display is, for example, an LCD, an organic EL display, or the like. However, the interface for display is not limited to this.

### (Flow of Operations of Video Management Apparatus)

Operations of the video management apparatus 30 according to the present embodiment will be described with reference to FIG. 3.

Step S101: the input interface 41 of the terminal apparatus 40 accepts the designation of a point, on the map displayed on the screen, at which to acquire video.

The input interface 41 of the terminal apparatus 40 accepts the designation by the user of the point on the map at which acquisition of video is desired. Next, the communication interface 42 transmits position coordinates indicating the point to the communication interface 31 of the video management apparatus 30 via the network 2.

Step S102: the controller 33 of the video management apparatus 30 capable of communicating with the terminal apparatus 40 displays, on the map displayed on the screen of the terminal apparatus 40, an icon indicating a position and an orientation, at a time at which a video was captured, of each vehicle 10 that stores the video, the video having been captured within a predetermined area including the designated point on the map.

Information such as the position and orientation of each vehicle 10 at the time the video was captured is necessary information for selecting video or images. However, the conventional technologies disclosed in PTL 1 and the like do not properly present such information to the user.

According to the present disclosure, the user can grasp at a glance the position and orientation at which a video was captured by viewing the icon displayed on the map. This makes it easier for the user to select the vehicle 10 that stores video captured at the desired position and orientation. The display screen with the icon corresponding to each vehicle is updated at predetermined time intervals (for example, every 10 seconds).

The communication interface 21 of the data center 20 receives the time the video was captured and the positional information for the vehicle 10 at the time the video was captured from each vehicle 10 at predetermined time intervals (for example, every 10 seconds). The controller 23 then stores data D formed by a combination of such information in the memory 22. For example, the data D for each vehicle 10 is managed as the combination of the capture time (year/month/day/time), the positional information for the vehicle 10, and the captured video, as illustrated in Equation (1). The time is x hours, y minutes, and z seconds and is updated in units of seconds. Based on the positional information, which is data including the position and orientation of the vehicle 10, an icon to be displayed on the map is generated to indicate the position and orientation of the vehicle 10.

Data D=(capture time,positional information for vehicle,video) (1)

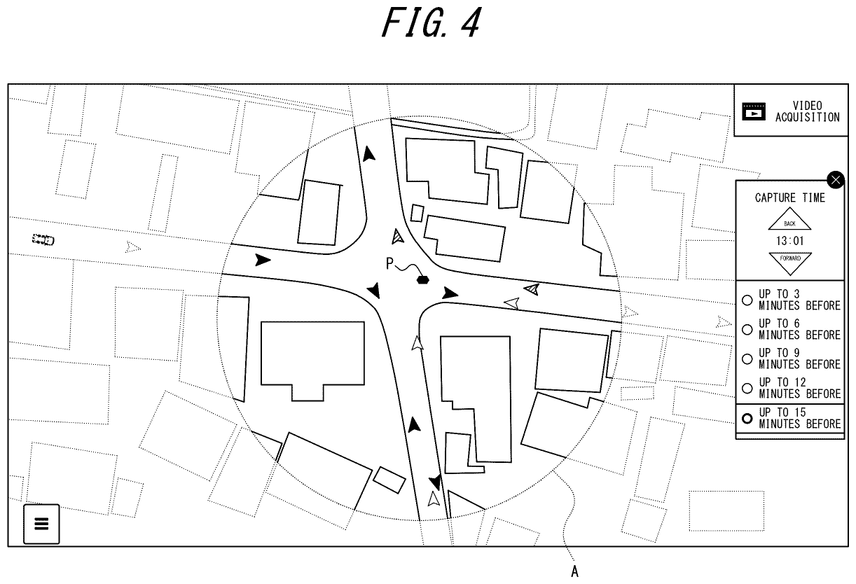

The controller 33 may allow designation, on the screen of the terminal apparatus 40, of the target period for acquiring the video. Upon the target period being designated, the controller 33 displays, on the map, the icon of each vehicle that stores a video captured during the target period in the predetermined area. As illustrated in FIG. 4, upon the “capture time” being designated as “13:01” and the target period being set as “up to 15 minutes before”, icons indicating the position and orientation of vehicles 10 located inside a concentric predetermined area A during the time period from “12:46” to “13:01” are plotted on the map and displayed. By the target period being set, a greater amount of vehicle positional information can be displayed during time slots in which there are few vehicles capable of acquiring video, thereby increasing the parameter of the number of vehicles capable of acquiring video. The “capture time” is inputted manually, but the time at which the last video at the designated point was captured may be inputted automatically.

The controller 33 of the video management apparatus 30 acquires, from the data center 20, data D1 that is a combination, among the above-described data D, of the time and positional information for the video captured by each vehicle 10. The data D1 is the data indicated in Equation (2) below. Based on the positional information, which is data including the position and orientation of the vehicle 10, the position and orientation of the vehicle 10 to be displayed on the map are acquired. From the data D1 for the vehicle 10, an icon indicating the position and orientation at the time the vehicle 10 captured the video can thus be generated.

Data D1=(capture time,positional information for vehicle) (2)

Upon designation of the point P for which video is to be acquired, the controller 33 defines the predetermined area A that includes the point P. The predetermined area A may, for example, be the area represented by a concentric circle extending from the designated point P by a predetermined radius, as illustrated in FIG. 4, or the area represented by a square centered on the designated point P, though these examples are not limiting. As illustrated in FIG. 4, the controller 33 plots and displays, on the map, icons indicating the position and orientation of the vehicles 10 located inside the concentric predetermined area A within the designated target period.

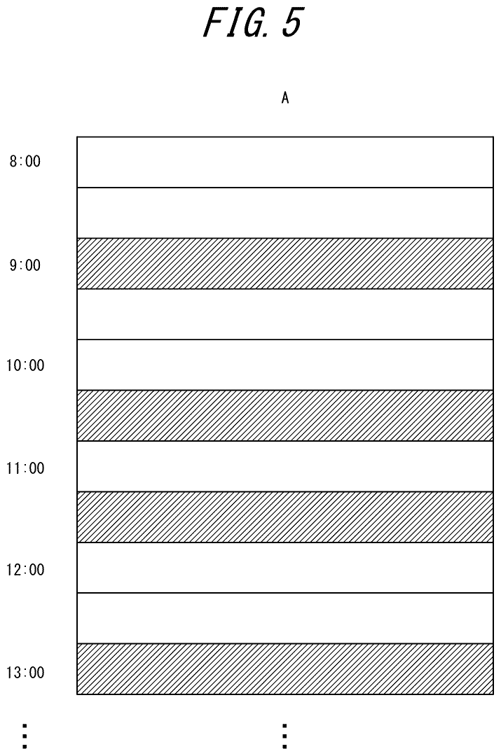

Furthermore, the controller 33 displays, on the screen of the terminal apparatus 40, information indicating the time the video was captured for each vehicle 10 that stores the video captured within the predetermined area A. FIG. is a diagram illustrating an example of a screen displaying information indicating the time at which a video was captured. In the screen illustrated in FIG. 5, the shaded time slots indicate time slots for which captured video is stored. In other words, as the information indicating the time at which a video was captured, the time slot to which the time belongs is displayed in a visually distinguishable manner in the example illustrated in FIG. 5. From the example illustrated in FIG. 5, it is clear that within the predetermined area A, captured video is stored for the time slots 9:00-9:30, 10:30-11:00, 11:30-12:00, and 13:00-13:30. Therefore, if the user designates the target period on the video acquisition screen in FIG. 4 after first confirming the information displayed on the screen in FIG. 5, the efficiency for retrieving the desired video will improve. In the example in FIG. 5, the time slots are set at 30-minute intervals, but the time slots may be set at shorter intervals, such as 10 minutes or 5 minutes, or at longer intervals, such as 60 minutes.

The controller 33 may display, on the map, the icon indicating the position and the orientation of one or more vehicles 10 that captured the video in the predetermined area A during the target period by changing the color of the icon for different times. Displaying the icon by changing the color of the icon for different times makes it possible to clearly identify the time to which the vehicle corresponds. In addition, the search efficiency is improved, since it is possible to know whether there is a vehicle capable of acquiring video within the target period.

For example, the color of the icons is described with reference to FIG. 4. (i) The black icons (represented as a dark color in FIG. 4) indicate the latest position of the vehicles 10 (the position at the capture time of “13:01”). (ii) The white icons (represented as white in FIG. 4) indicate the past positions of the vehicles 10 (positions in the time slot from “12:46” to “13:01”). Furthermore, (iii) the green icons (represented as hatching in FIG. 4) indicate the position of the vehicles 10 for which video has been saved in the memory 32, as described below.

Steps S103 to S104: the controller 33 acquires, upon any icon being selected from among one or more icons displayed on the map, the video captured by the vehicle 10 corresponding to the selected icon.

The input interface 41 of the terminal apparatus 40 accepts the selection of an icon upon the user clicking the “acquire video” button in the upper right corner of FIG. 4 after selecting any one of the icons displayed on the map. The communication interface 42 transmits the accepted information to the communication interface 31 of the video management apparatus 30 via the network 2.

Upon selection of one of the icons, the controller 33 of the video management apparatus 30 acquires, from the data center 20, the data for the video in the data D at the capture time of the vehicle 10 corresponding to the selected icon. Upon acquiring the target video, the controller 33 performs an appropriate mask process on the video and places the video in a playable state. The video in a playable state is stored in the memory 32 until a playback request is received. The mask process is a process to protect personal information, such as a frosted glass process, though this example is not limiting.

Step S105: the controller 33 plays back the acquired video on the screen of the terminal apparatus 40.

Upon receipt of a playback request, the controller 33 plays back the target video on the screen of the terminal apparatus 40. The controller 33 may also store a video that has been played back a predetermined number of times as a history in the memory 32 of the video management apparatus 30. The keeping of a past history makes it possible to play back video without having to acquire the video from the data center 20 again. For example, the video history may be stored for one month and then deleted.

Step S106: in the case of further acquiring video, the controller 33 returns to step S103, whereas in the case of not further acquiring video, the controller 33 ends the process of acquiring and playing back the video.

The controller 33 repeats the process of acquiring and playing back video until the user acquires the desired video.

As described above, the video management apparatus 30 according to the present embodiment displays, on a map displayed on a screen of the communicably connected terminal apparatus 40, an icon indicating a position and an orientation, at a time at which a video is captured, of each vehicle 10 that stores the video, the video having been captured within a predetermined area including a designated point on the map. The video management apparatus 30 acquires, upon any icon being selected from among icons displayed on the map, the video captured by the vehicle 10 corresponding to the selected icon and plays back the acquired video.

According to such a configuration, an icon indicating the position and orientation of the vehicle 10 at the time at which the video was captured, which is necessary information for selecting the video of the vehicle 10, is displayed on the map. This improves the technology for managing video captured by vehicles in that the probability of acquiring the desired video increases.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the video management apparatus 30 in the above embodiment are distributed to multiple computers capable of communicating with each other can be implemented. For example, an embodiment in which some or all of the components of the video management apparatus 30 are provided in the data center 20 can also be implemented. Furthermore, the video management apparatus 30 may communicate with the vehicle 10 via the network 2 without passing through the data center 20 and may thus acquire the data D, which is a combination of the capture time (year/month/day/time), the positional information for the vehicle, and the video, stored in the vehicle 10.

In the embodiment described above, the data center 20 may receive the data D1, which is a combination of the time the video was captured and the positional information for the vehicle 10 at the time the video was captured, from each vehicle 10 at predetermined time intervals. In such a case, the video management apparatus 30 issues a request, upon any icon being selected from among one or more icons displayed on the map, to the data center 20 for transmission of the video captured by the vehicle 10 corresponding to the selected icon. The data center 20 that receives transmission requests may then, upon each receipt of a video transmission request, acquire the requested video from the one corresponding vehicle 10 and subsequently transmit the acquired video to the video management apparatus 30.

In the embodiment described above, in a case in which two or more icons are selected on the map, the controller 33 of the video management apparatus 30 may acquire the video corresponding to the two or more icons from the data center 20 and play back each acquired video on the screen of the terminal apparatus 40 side by side. In a case in which two or more videos are acquired simultaneously from one vehicle 10, problems such as a reduction in the speed at which the videos are acquired may occur due to restrictions on the line speed of the network 2. By contrast, a configuration may be adopted so that in a case in which two or more icons with different capture times are displayed for one vehicle, and one icon among the two or more icons is selected, icons other than the one icon are grayed out and excluded as targets of operation. Adopting such a configuration reduces the probability of the aforementioned problems.

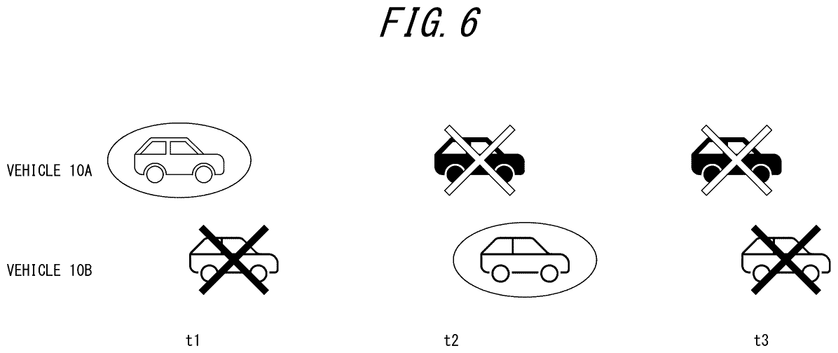

For example, as illustrated in FIG. 6, in a case in which the icons of vehicle 10A and vehicle 10B at times t1, t2, and t3 are displayed on the map, and the icon of vehicle 10A at time t1 and the icon of vehicle 10B at time t2 are selected, the icons other than these icons are grayed out and excluded as targets of operation. Even in a case in which the videos of two or more vehicles 10 need to be acquired simultaneously, this alleviates delays in the line speed as compared to a configuration in which all icons are targeted for selection.

For example, an embodiment in which a general purpose computer functions as the video management apparatus 30 according to the above embodiment can also be implemented. Specifically, a program in which processes for realizing the functions of the video management apparatus 30 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.
[Appendix 1] A video management apparatus capable of communicating with a terminal apparatus, the video management apparatus comprising: a controller configured to display, on a map displayed on a screen of the terminal apparatus, an icon indicating a position and an orientation, at a time at which a video is captured, of each vehicle that stores the video, the video having been captured within a predetermined area including a designated point on the map, acquire, upon any icon being selected from among one or more icons displayed on the map, a video captured by the vehicle corresponding to the selected icon, and play back the acquired video.
[Appendix 2] The video management apparatus according to appendix 1, wherein upon a target period being designated, the controller is configured to display, on the map, the icon of each vehicle that stores a video captured during the target period in the predetermined area.
[Appendix 3] The video management apparatus according to appendix 2, wherein the controller is configured to display, on the screen of the terminal apparatus, information indicating a time at which the video captured in the predetermined area was captured for each vehicle that stores the video.
[Appendix 4] The video management apparatus according to appendix 3, wherein the controller is configured to display, on the map, the icon indicating the position and the orientation of one or more vehicles that captured the video in the predetermined area during the target period by changing a color of the icon for different times.
[Appendix 5] The video management apparatus according to any one of appendices 1 to 4, wherein the controller is configured to store, as a history, a video that has been played back a predetermined number of times.
[Appendix 6] The video management apparatus according to any one of appendices 1 to 5, wherein upon two or more icons being selected on the map, the controller is configured to acquire video corresponding to the two or more icons and play back each acquired video on the screen side by side.
[Appendix 7] The video management apparatus according to appendix 6, wherein in a case in which two or more icons with different capture times are displayed for one vehicle, the controller is configured, upon one icon among the two or more icons being selected, to gray out icons other than the one icon.
[Appendix 8] A video management method to be executed by a video management apparatus capable of communicating with a terminal apparatus, the video management method comprising:
   displaying, on a map displayed on a screen of the terminal apparatus, an icon indicating a position and an orientation, at a time at which a video is captured, of each vehicle that stores the video, the video having been captured within a predetermined area including a designated point on the map;
   acquiring, upon any icon being selected from among one or more icons displayed on the map, a video captured by the vehicle corresponding to the selected icon; and
   playing back the acquired video.
[Appendix 9] The video management method according to appendix 8, further comprising displaying on the map, upon a target period being designated, the icon of each vehicle that stores a video captured during the target period in the predetermined area.
[Appendix 10] The video management method according to appendix 9, further comprising displaying, on the screen of the terminal apparatus, information indicating a time at which the video captured in the predetermined area was captured for each vehicle that stores the video.
[Appendix 11] The video management method according to appendix 10, further comprising displaying, on the map, the icon indicating the position and the orientation of one or more vehicles that captured the video in the predetermined area during the target period by changing a color of the icon for different times.
[Appendix 12] The video management method according to any one of appendices 8 to 11, further comprising storing, as a history, a video that has been played back a predetermined number of times.
[Appendix 13] The video management method according to any one of appendices 8 to 12, further comprising:
   acquiring, upon two or more icons being selected on the map, video corresponding to the two or more icons; and
   playing back each acquired video on the screen side by side.
[Appendix 14] The video management method according to appendix 13, further comprising, in a case in which two or more icons with different capture times are displayed for one vehicle, graying out, upon one icon among the two or more icons being selected, icons other than the one icon.
[Appendix 15] A non-transitory computer readable medium storing a program configured to cause a video management apparatus capable of communicating with a terminal apparatus to execute operations, the operations comprising:
   displaying, on a map displayed on a screen of the terminal apparatus, an icon indicating a position and an orientation, at a time at which a video is captured, of each vehicle that stores the video, the video having been captured within a predetermined area including a designated point on the map;
   acquiring, upon any icon being selected from among one or more icons displayed on the map, a video captured by the vehicle corresponding to the selected icon; and
   playing back the acquired video.
[Appendix 16] The medium according to appendix 15, wherein the operations further comprise displaying on the map, upon a target period being designated, the icon of each vehicle that stores a video captured during the target period in the predetermined area.
[Appendix 17] The medium according to appendix 16, wherein the operations further comprise displaying, on the screen of the terminal apparatus, information indicating a time at which the video captured in the predetermined area was captured for each vehicle that stores the video.
[Appendix 18] The medium according to appendix 17, wherein the operations further comprise displaying, on the map, the icon indicating the position and the orientation of one or more vehicles that captured the video in the predetermined area during the target period by changing a color of the icon for different times.
[Appendix 19] The medium according to any one of appendices 15 to 18, wherein the operations further comprise storing, as a history, a video that has been played back a predetermined number of times.
[Appendix 20] The medium according to any one of appendices 15 to 19, wherein the operations further comprise:
   acquiring, upon two or more icons being selected on the map, video corresponding to the two or more icons; and
   playing back each acquired video on the screen side by side.

1. A video management apparatus capable of communicating with a terminal apparatus, the video management apparatus comprising:
a controller configured to display, on a map displayed on a screen of the terminal apparatus, an icon indicating a position and an orientation, at a time at which a video is captured, of each vehicle that stores the video, the video having been captured within a predetermined area including a designated point on the map, acquire, upon any icon being selected from among one or more icons displayed on the map, a video captured by the vehicle corresponding to the selected icon, and play back the acquired video.

2. The video management apparatus according to claim 1, wherein upon a target period being designated, the controller is configured to display, on the map, the icon of each vehicle that stores a video captured during the target period in the predetermined area.

3. The video management apparatus according to claim 2, wherein the controller is configured to display, on the screen of the terminal apparatus, information indicating a time at which the video captured in the predetermined area was captured for each vehicle that stores the video.

4. The video management apparatus according to claim 3, wherein the controller is configured to display, on the map, the icon indicating the position and the orientation of one or more vehicles that captured the video in the predetermined area during the target period by changing a color of the icon for different times.

5. The video management apparatus according to claim 1, wherein the controller is configured to store, as a history, a video that has been played back a predetermined number of times.

6. The video management apparatus according to claim 1, wherein upon two or more icons being selected on the map, the controller is configured to acquire video corresponding to the two or more icons and play back each acquired video on the screen side by side.

7. The video management apparatus according to claim 6, wherein in a case in which two or more icons with different capture times are displayed for one vehicle, the controller is configured, upon one icon among the two or more icons being selected, to gray out icons other than the one icon.

8. A video management method to be executed by a video management apparatus capable of communicating with a terminal apparatus, the video management method comprising:
displaying, on a map displayed on a screen of the terminal apparatus, an icon indicating a position and an orientation, at a time at which a video is captured, of each vehicle that stores the video, the video having been captured within a predetermined area including a designated point on the map;
acquiring, upon any icon being selected from among one or more icons displayed on the map, a video captured by the vehicle corresponding to the selected icon; and
playing back the acquired video.

9. The video management method according to claim 8, further comprising displaying on the map, upon a target period being designated, the icon of each vehicle that stores a video captured during the target period in the predetermined area.

10. The video management method according to claim 9, further comprising displaying, on the screen of the terminal apparatus, information indicating a time at which the video captured in the predetermined area was captured for each vehicle that stores the video.

11. The video management method according to claim 10, further comprising displaying, on the map, the icon indicating the position and the orientation of one or more vehicles that captured the video in the predetermined area during the target period by changing a color of the icon for different times.

12. The video management method according to claim 8, further comprising storing, as a history, a video that has been played back a predetermined number of times.

13. The video management method according to claim 8, further comprising:
acquiring, upon two or more icons being selected on the map, video corresponding to the two or more icons; and
playing back each acquired video on the screen side by side.

14. The video management method according to claim 13, further comprising, in a case in which two or more icons with different capture times are displayed for one vehicle, graying out, upon one icon among the two or more icons being selected, icons other than the one icon.

15. A non-transitory computer readable medium storing a program configured to cause a video management apparatus capable of communicating with a terminal apparatus to execute operations, the operations comprising:
displaying, on a map displayed on a screen of the terminal apparatus, an icon indicating a position and an orientation, at a time at which a video is captured, of each vehicle that stores the video, the video having been captured within a predetermined area including a designated point on the map;
acquiring, upon any icon being selected from among one or more icons displayed on the map, a video captured by the vehicle corresponding to the selected icon; and
playing back the acquired video.

16. The medium according to claim 15, wherein the operations further comprise displaying on the map, upon a target period being designated, the icon of each vehicle that stores a video captured during the target period in the predetermined area.

17. The medium according to claim 16, wherein the operations further comprise displaying, on the screen of the terminal apparatus, information indicating a time at which the video captured in the predetermined area was captured for each vehicle that stores the video.

18. The medium according to claim 17, wherein the operations further comprise displaying, on the map, the icon indicating the position and the orientation of one or more vehicles that captured the video in the predetermined area during the target period by changing a color of the icon for different times.

19. The medium according to claim 15, wherein the operations further comprise storing, as a history, a video that has been played back a predetermined number of times.

20. The medium according to claim 15, wherein the operations further comprise:
acquiring, upon two or more icons being selected on the map, video corresponding to the two or more icons; and
playing back each acquired video on the screen side by side.
